(19) United States
(12) Patent Application Publication
(10) Pub. No.: US 2013/0113733 A1
(43) Pub. Date: May 9, 2013

(54) DISPLAY PANEL AND MOBILE DEVICE WITH THE SAME

(71) Applicant: Samsung Electronics Co. Ltd., Suwon-si (KR)

(72) Inventors: Sil Kyu LIM, Hwaseong-si (KR); Dong Sub KIM, Suwon-si (KR)

(73) Assignee: Samsung Electronics Co. Ltd., Suwon-si (KR)

(21) Appl. No.: 13/655,818

(22) Filed: Oct. 19, 2012

(30) Foreign Application Priority Data
Nov. 8, 2011 (KR) 10-2011-0115771

(51) Int. Cl. G09F 13/18; G06F 3/041

(52) U.S. Cl. 345/173; 362/19

(57) ABSTRACT

A display panel and a mobile device with the display panel are provided. The display panel includes a display module and a back light unit. The display module includes a glass substrate for displaying videos by controlling a transmittance and a color of light, an upper polarizer that is placed on an upper side of the glass substrate, and a lower polarizer that is placed on a lower side of the glass substrate and exposes an edge of the glass substrate. The back light unit includes: a light source, a light waveguide that is placed on a lower side of the lower polarizer and that transfers light from the light source to the lower polarizer, and a Flexible Printed Circuit Board (FPCB), which is placed at the edge of the glass substrate exposed by the lower polarizer, that supplies electric power to the light source, and that reflects light from the light source to the light waveguide. The display panel is cost-effective and has high optical efficiency.

### PRIORITY

This application claims the benefit under 35 U.S.C. §119(a) of a Korean patent application filed on Nov. 8, 2011 in the Korean Intellectual Property Office and assigned Serial No. 10-2011-0115771, the entire disclosure of which is hereby incorporated by reference.

### BACKGROUND OF THE INVENTION

1. Field of the Invention

The present invention relates to a display panel with a Back Light Unit (BLU) and a mobile device with the display panel. More particularly, the present invention relates to a display panel which increases the light efficiency and that requires relatively low manufacturing costs.

2. Description of the Related Art

With the rapid development of information and communication technology and semiconductor technology, the use of various types of mobile devices has also increased. Because of mobile convergence, many mobile devices are configured to provide additional service functions provided by other types of mobile systems, in addition to the traditional service functions provided by mobile devices. For example, mobile devices may provide additional functions in addition to the general communication functions such as a voice call, and message transmission and reception. Examples of the additional functions that may be provided by a mobile device include a TV viewing function (e.g., mobile broadcasting, such as Digital Multimedia Broadcasting (DMB), Digital Video Broadcasting (DVB), etc.), a multi-media function (e.g., audio data playback (e.g., MPEG Audio Layer 3 (MP3), video data playback), and the like.

Mobile devices are equipped with display panels. Display panels display user data created when mobile devices execute functions. Advances in display panels have increased the brightness and visibility of the display. A display panel includes a module for displaying videos and a Back Light Unit (BLU), installed to the lower side of the module, for outputting light. A BLU includes a light source for outputting light and a Flexible Printed Circuit Board (FPCB) for supplying electric power to the light source. The FPCBs include a copper foil and a coverlay for protecting and for electrically isolating the copper foil.

However, display panels according to the related art are disadvantageous in that light is not efficiently transmitted from the BLU to the display module. That is, the coverlay inefficiently reflects light from the light source because it absorbs light. To resolve the problem, the coverlay is printed on the one side with silk. However, the silk-printed surface is so rough that the silk-printed surface has a limited ability to increase the reflectance. In addition, the addition of silk-printing and baking the printed silk causes the manufacturing costs to increase. In order to improve the light efficiency, display panels according the related art are manufactured in such a way that the FPCB reduces the width and a polarizer increases the width. However, because the polarizer increases the size of the display panel, the use of a polarizer increases the manufacturing costs.

Therefore, a need exists for a display panel that increases the light efficiency and that requires relatively low manufacturing costs.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a display panel that increases the light efficiency, and a mobile device with the display panel.

Another aspect of the present invention is to provide a display panel and a mobile device with the display panel that require low manufacturing costs.

In accordance with an aspect of the invention, a display panel including a display module and a back light unit is provided. The display module includes a glass substrate for displaying videos by controlling a transmittance and a color of light, an upper polarizer that is placed on an upper side of the glass substrate, and a lower polarizer that is placed on a lower side of the glass substrate and so as to expose an edge of the glass substrate. The back light unit includes: a light source, a light waveguide that is placed on a lower side of the lower polarizer and that transfers light from the light source to the lower polarizer, and a Flexible Printed Circuit Board (FPCB) is placed at the edge of the glass substrate exposed by the lower polarizer, that supplies electric power to the light source, and that reflects light from the light source to the light waveguide.

In accordance with another aspect of the invention, a mobile device including a display panel, and a touch panel, which is installed to an upper side of the display panel, for passing light from the display panel and for sensing the a presence of approaches or touches by a passive object is provided. The display panel includes a display module, and a back light unit. The display module includes a glass substrate for displaying videos by controlling a transmittance and a color of light, an upper polarizer that is placed on the an upper side of the glass substrate, and a lower polarizer that is placed on a lower side of the glass substrate and so as to exposes the an edge of the glass substrate. The back light unit includes a light source, for creating light, a light waveguide that is placed on a lower side of the lower polarizer and that transfers light from the light source to the lower polarizer, and a Flexible Printed Circuit Board (FPCB), which is placed at the edge of the glass substrate exposed by the lower polarizer, that supplies electric power to the light source, and that reflects light from the light source to the light waveguide.

In accordance with another aspect of the invention, a display panel including a display module and a back light unit is provided. The display module includes a glass substrate for selectively transmitting light, and a lower polarizer that is arranged on a lower side of the glass substrate and that is configured to cover a portion of the glass substrate so as to expose an edge of the glass substrate. The back light unit includes a light source, a light waveguide that is arranged on a lower side of the lower polarizer and that transfers light from the light source to the lower polarizer, and a Flexible Printed Circuit Board (FPCB), which is placed at the edge of the glass substrate exposed by the lower polarizer, that supplies electric power to the light source, and that reflects light from the light source to the light waveguide.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates an exploded perspective view of a display panel according to an exemplary embodiment of the present invention;

FIG. 2 illustrates a cross-sectional view of a primary part of a display panel according to an exemplary embodiment of the present invention;

FIG. 3 illustrates a perspective view of a mobile device with a display panel according to an exemplary embodiment of the present invention; and

FIG. 4 illustrates an exploded perspective view of a mobile device with a display panel according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be understood that a display panel according to exemplary embodiments of the present invention can be applied to all types of electronic devices including mobile devices if the electronic devices have displays and input units. The mobile device with the display panel includes all information communication devices, multimedia devices, and applications associated with such devices, which are operated according to communication protocols corresponding to various types of communication systems. For example, the mobile device can be applied to mobile communication terminals, digital broadcast players, Personal Digital Assistants (PDAs), smartphones, tablet personal computers, hand-held Personal Computers (PCs), etc. In the following description, it is assumed that mobile devices are smart phones.

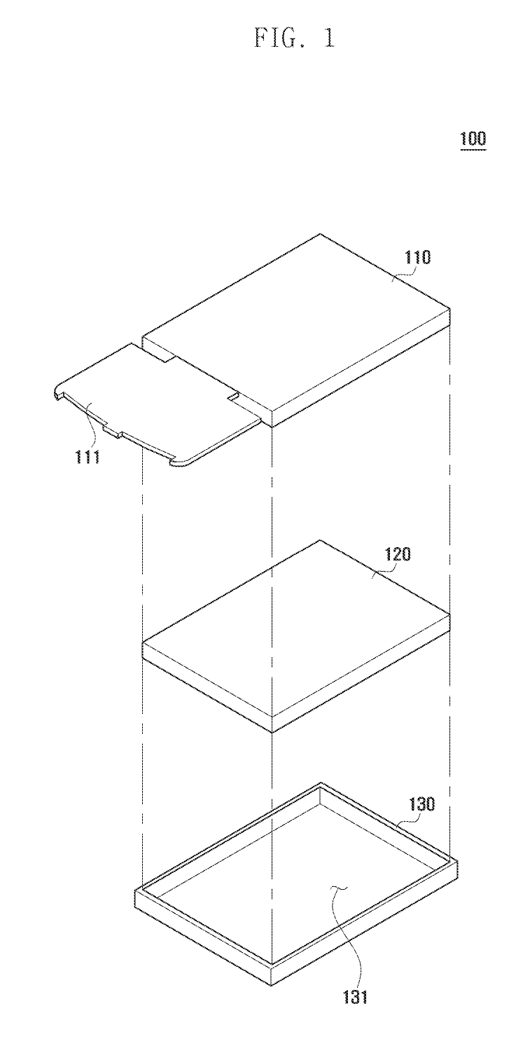

FIG. 1 illustrates an exploded perspective view of a display panel according to an exemplary embodiment of the present invention.

Referring to FIG. 1, the display panel 100 includes a display module 110, a back light unit 120, and a module bracket 130.

The display module 110 converts video data from the controller of the mobile device to analog signals, in the Flexible Printed Circuit Board (FPCB) 111, and displays videos. According to exemplary embodiments of the present invention, the display module 110 may be implemented with a Liquid Crystal Display (LCD).

The back light unit 120 is installed to the lower side of the display module 110 and provides light thereto. The display module 110 displays videos by controlling the color and the transmittance of light from the back light unit 120.

The module bracket 130 forms reception space 131 in which the display module 110 and the back light unit 120 are fixedly placed.

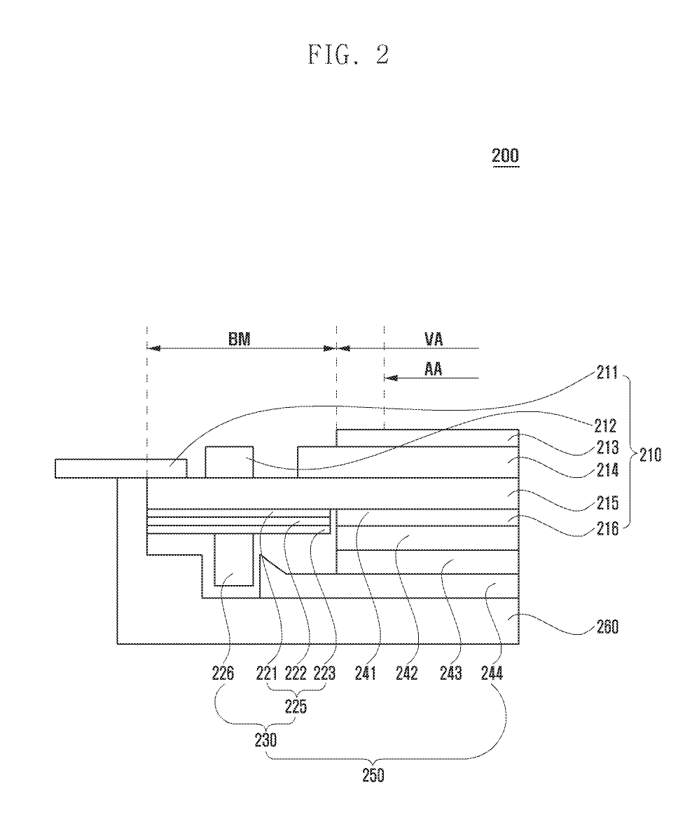

FIG. 2 illustrates a cross-sectional view of a primary part of a display panel according to an exemplary embodiment of the present invention.

Referring to FIG. 2, the display panel 200 includes a display module 210, a back light unit 250, and a module bracket 260.

The display panel 200 is installed to the lower side of the touch panel of the mobile device. The touch panel is exposed to the outside and senses the presence of the approach or touch by passive objects (e.g., fingers). The display panel 200 includes a first FPCB 211, a drive module 212, an upper polarizer 213, an upper glass substrate 214, a lower glass substrate 215, and a lower polarizer 216. It should be understood that liquid crystal is injected, forming a layer, between the upper 214 and lower 215 glass substrates. According to exemplary embodiments of the present invention, the first FPCB 211 supplies electric power from the battery of the mobile device (not shown) to the drive module 212. The first FPCB 211 transfers control signals from the controller to the drive module 212. The drive module 212 controls the upper polarizer 213, the lower polarizer 216, the upper glass substrate 214, the lower glass substrate 215, and operatively displays videos.

The lower polarizer 216 is placed between the lower glass substrate 215 and the back light unit 250. For example, according to exemplary embodiments of the present invention, the lower polarizer 216 is placed in such a way so as to expose the edge of the lower side of the lower glass substrate 215. That is, the lower polarizer 216 is placed in the center portion on the lower side of the lower glass substrate 215, so that an optical module 230, described later, is placed in situ. The lower polarizer 216 passes only light of a specific polarization from the back light unit 250 and blocks waves of the other polarizations. The lower glass substrate 215 is placed on the upper side of the lower polarizer 216. The lower glass substrate 215 controls the transmittance of light from the back light unit 250. To this end, the lower glass substrate 215 controls the alignment of liquid crystal under the control of the drive module 212, thereby controlling the transmission of light polarized by the lower polarizer 216. As an example, the lower glass substrate 215 may be implemented with a Thin Film Transistor (TFT) substrate.

The upper glass substrate 214 is placed above the lower glass substrate 215. The upper glass substrate 214 outputs light corresponding to a certain color passing through the liquid layer. The upper glass substrate 214 may be implemented with a color filter corresponding to red-, green- and blue-pixels. The upper polarizer 213 is placed on the upper glass substrate 214. The upper polarizer 213 passes light of polarizations from the upper glass substrate 214. The upper polarizer 213 also passes light of a specific polarization outside the mobile device to the inside and blocks waves of other polarizations.

The display module 210 is divided into a black matrix area and a view area. The view area refers to the center portion of the display module 210, which is also called an active area. The active area (not shown) refers to a sensing area that senses the presence of an approach or touch by a passive object (e.g., a finger, a stylus, and/or the like) on the touch panel. The view area also refers to an area that passes light from the display module 210 through the touch panel. The black matrix area refers to the peripheral area of the view area. The black matrix area corresponds to the edge area of the display module 210 that blocks light.

The back light unit 250 includes an optical module 230, an upper prism sheet 241, a lower prism sheet 242, a diffuse sheet 243 and a light waveguide 244.

The optical module 230 includes a second FPCB 225 and a light source 226.

The second FPCB 225 is placed on the edge of the lower side of the lower glass substrate 215. The second FPCB 225 is arranged so as not to invade the view area. The second FPCB 225 supplies electric power from the battery to the light source 226. The second FPCB 225 reflects light from the light waveguide 244 and from the light source 226 to the light waveguide 244. The second FPCB 225 includes an upper coverlay 221, an electric power supply circuit 222, and a lower coverlay 223. The electric power supply circuit 222 is placed between the upper coverlay 221 and lower coverlay 223, and the electric power supply circuit 222 supplies electric power from the battery to light source 226. The electric power supply circuit 222 is implemented with a copper film. The upper coverlay 221 and lower coverlay 223 protect and electrically isolate the electric power supply circuit 222. The lower coverlay 223 is implemented with a white-colored film to reflect light from the light waveguide 244 and from the light source 226 to the light waveguide 244, without absorption. The upper coverlay 221 is attached to the edge of the lower side of the lower glass substrate 215.

The light source 226 is placed on the lower side of the lower coverlay 223. Alternatively, the light source 226 may be placed at the side of the light waveguide 244. The lower coverlay 223 have via halls (not shown) through which the light source 226 and the electric power supply circuit 222 are electrically connected to each other. The light source 226 may be implemented with a linear light source, such as a Cold Cathode Fluorescent Lamp (CCFL), a Hot Cathode Fluorescent Lamp (HCFL), or the like. The light source 226 may also be implemented with a point light source such as Light Emitting Diodes (LEDs).

The light waveguide 244 is placed on the upper side of the module bracket 260, and transfers light from the light source 226 to the display module 210. The light waveguide 244 receives light from the light source 226 (e.g., a point light source or a linear light source), and guides the light to the diffuse sheet 243 serving as a surface light source. As an example, the light waveguide 244 may be implemented with transparent, plastic materials, such as acrylic. The light waveguide 244 may form a pattern so as to uniformly transfer light from the light source 226 to the view area of the display module 210. As an example, the pattern may be formed on the light waveguide 244 in the vapor deposition method.

The diffuse sheet 243 is placed on the light waveguide 244. The diffuse sheet 243 scatters light from the light waveguide 244 so as to uniformly transfer light to the lower prism sheet 242. According to exemplary embodiments of the present invention, the diffuse sheet 243 is operatively installed in the display panel 200 when light from the light waveguide 244 is required to be more uniform.

The lower prism sheet 242 is placed on the upper side of the diffuse sheet 243. The upper prism sheet 241 is placed on the upper side of the lower prism sheet 242. That is, the upper prism sheet 241 is placed between the lower polarizer 216 and the lower prism sheet 242. The upper 241 and lower 242 prism sheets increases the brightness. For example, the upper 241 and lower 242 prism sheets refract and collect light from the diffuse sheet 243 and transfer the light to the display module 110 (i.e., the upper prism sheet 241 and the lower prism sheet 242 transfer the light to the lower polarizer 216). According to exemplary embodiments of the present invention, the lower prism sheet 242 may be a vertical prism sheet that diffuses light in the vertical direction. Likewise, the upper prism sheet 241 may be a horizontal prism sheet that diffuses light in the horizontal direction.

Although it is not shown in the drawings, according to exemplary embodiments of the present invention, a reflection sheet may be placed between the light waveguide 244 and the module bracket 260 in order to reflect light from the lower surface of the light waveguide 244 inside the light waveguide 244.

According to exemplary embodiments of the present invention, the display modules as configured above are advantageous as follows. The coverlay (i.e., the lower coverlay 223) protects and electrically isolates the electric power supply circuit 222 and reflects light from the light source 226 to the light waveguide 224, without absorption. This increases the brightness in the display panel, without the use of silk which is used in display panels according to the related art. Therefore, the display panel according to exemplary embodiments of the present invention does not need a silk printing process and the baking process. Accordingly, the manufacturing costs associated with manufacturing display panels according to exemplary embodiments of the present invention may be reduced relative to the manufacturing costs associated with manufacturing display panels according to the related art. The second FPCB 225 may be designed to be as wide as possible, as long as the second FPCB does not invade the view area. Meanwhile, the lower polarizer 216 may reduce the width to the view area, which decreases the manufacturing costs. In the following description, the mobile device with the panel will be explained in detail.

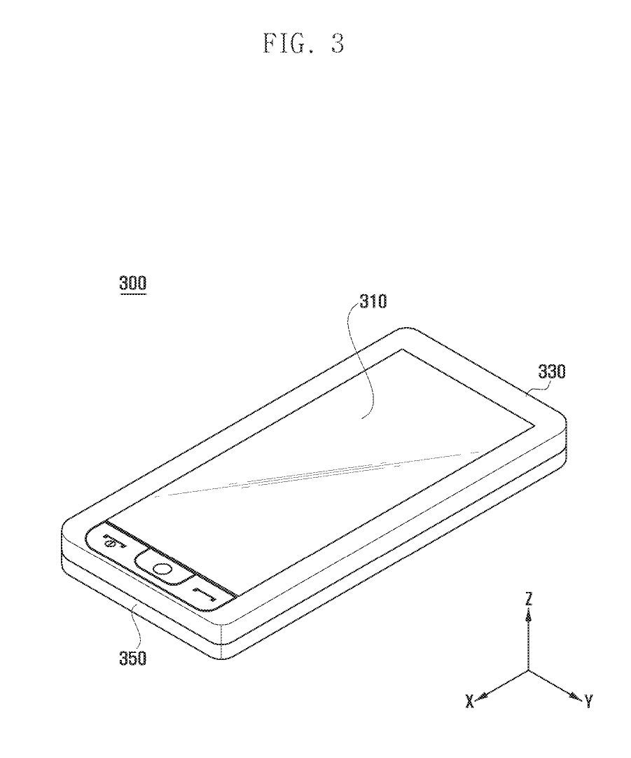

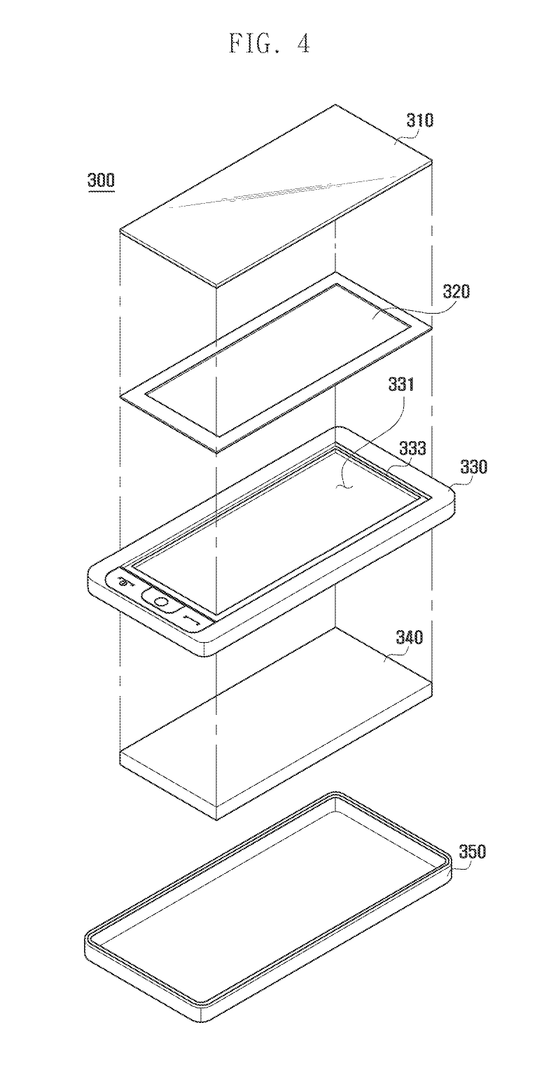

FIG. 3 illustrates a perspective view of a mobile device with a display panel according to an exemplary embodiment of the present invention. FIG. 4 illustrates an exploded perspective view of a mobile device with a display panel according to an exemplary embodiment of the present invention.

Referring to FIGS. 3 and 4, the mobile device 300 includes a touch panel 310, a cover adhesive sheet 320, a cover chassis 330, a display panel 340 and a panel bracket 350.

The touch panel 310 is installed on the display panel 340 and protects the components in the mobile device 300. The touch panel 310 senses the presence of touches according to user's gestures, creates touch events associated with touches, and transfers signals corresponding to the touch events to the controller. The controller controls the entire operation of the mobile device and the signals flowing among the components, and processes data, according to the signals corresponding to the touch events. As an example, the touch panel 310 may be implemented with various types of sensors, such as a capacitive type, an electromagnetic induction type, the like, or a combination thereof.

The cover adhesive sheet 320 couples the components of the mobile device, such as, the touch panel 310, the cover chassis 330 and the display panel 340, to each other. The cover adhesive sheet 320 may be shaped as a frame type of tape (e.g., a tape with Optical Clear Adhesive (OCA) or Super View Resin (SVR)).

The cover chassis 330 protects the components in the mobile device 300, with the touch panel 310. The cover chassis 330 is made of synthetic resin, or metal such as stainless steel or Titanium (Ti), and/or the like. The cover chassis 330 includes a reception space 331 formed therein. The reception space 331 formed in the cover chassis 330 receives the touch panel 310 via the cover adhesive sheet 320. The cover chassis 330 also comprises a receipt stopper 333 formed around the reception space 331. The receipt stopper 333 protrudes towards the center and allows for the placement of the touch panel 310, by supporting the cover adhesive sheet 320. That is, the receipt stopper 333 supports the touch panel 310.

The display panel 340 is placed under the reception space 331 of the cover chassis 330 opposite the touch panel 310. The display module 340 is protected by the touch panel 310 and the cover chassis 330.

The panel bracket 350 fixes the internal components in the mobile device 100 to the body. The panel bracket 350 allows for the placement of the display module 340. For example, the panel bracket 350 protects the internal components, with the touch panel 310 and the cover chassis 330. The panel bracket 350 is formed as the shape of the body of the mobile device 300. That is, the panel bracket 350 operatively forms the internal space, by coupling to the cover chassis 330 with the edge.

As described above, the cover adhesive sheet 320 couples the touch panel 310, the cover chassis 330, and the display module 340 to each other. The coupling of the touch panel 310, the cover chassis 330 and the panel bracket 350 forms the internal space in which the display module 340 is placed.

As described above, the display panel and the mobile device with the same, according to exemplary embodiments of the present invention, can perform a display operation with a relatively high light efficiency. In addition, the display panel and the mobile device with the same can be manufactured with cost-effectiveness.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A display panel comprising:
a display module; and
a back light unit,
wherein the display module comprises: a glass substrate for displaying videos by controlling a transmittance and a color of light, an upper polarizer that is placed on an upper side of the glass substrate, and a lower polarizer that is placed on a lower side of the glass substrate so as to expose an edge of the glass substrate, and
wherein the back light unit comprises: a light source, a light waveguide that is placed on a lower side of the lower polarizer and that transfers light from the light source to the lower polarizer, and a Flexible Printed Circuit Board (FPCB), which is placed at the edge of the glass substrate exposed by the lower polarizer, that supplies electric power to the light source, and that reflects light from the light source to the light waveguide.

2. The display panel of claim 1, wherein:
the display module further comprises a view area for displaying videos and a black matrix area, corresponding to the peripheral area of the view area, for blocking light from the light source, and
the FPCB is placed at the edge of the glass substrate and is arranged such that the FPCB does not invade the view area of the display module.

3. The display panel of claim 2, wherein the lower polarizer is placed in an area on the lower side of the glass substrate, corresponding to the view area.

4. The display panel of claim 1, wherein the FPCB comprises:
an electric power supply circuit connected to the light source; and
a coverlay for protecting and electrically isolating the electric power supply circuit and for reflecting light from the light source to the light waveguide.

5. The display panel of claim 4, wherein the coverlay is white.

6. A mobile device comprising:
a display panel; and
a touch panel, which is installed to an upper side of the display panel, for passing light from the display panel and for sensing a presence of approaches or touches by a passive object,
wherein the display panel comprises:
a display module; and
a back light unit,
wherein the display module comprises: a glass substrate for displaying videos by controlling a transmittance and a color of light, an upper polarizer that is placed on an upper side of the glass substrate, and a lower polarizer that is placed on a lower side of the glass substrate so as to expose an edge of the glass substrate, and
wherein the back light unit comprises: a light source, a light waveguide that is placed on a lower side of the lower polarizer and that transfers light from the light source to the lower polarizer, and a Flexible Printed Circuit Board (FPCB), which is placed at the edge of the glass substrate exposed by the lower polarizer, that supplies electric power to the light source, and that reflects light from the light source to the light waveguide.

7. The mobile device of claim 6, wherein:
the display module further comprises a view area for displaying videos and a black matrix area, corresponding to the peripheral area of the view area, for blocking light from the light source, and
the FPCB is placed at the edge of the glass substrate and is arranged such that the FPCB does not invade the view area.

8. The mobile device of claim 7, wherein the lower polarizer is placed in an area on the lower side of the glass substrate, corresponding to the view area.

9. The mobile device of claim 6, wherein the FPCB comprises:
an electric power supply circuit connected to the light source; and
a coverlay for protecting and electrically isolating the electric power supply circuit and for reflecting light from the light source to the light waveguide.

10. The mobile device of claim 9, wherein the coverlay is white.

11. A display panel comprising:
a display module for displaying images; and
a back light unit for providing light to the display module,
wherein the display module comprises: a glass substrate for selectively transmitting light, and a lower polarizer that is arranged on a lower side of the glass substrate and that is configured to cover a portion of the glass substrate so as to expose an edge of the glass substrate, and
wherein the back light unit comprises: a light source, a light waveguide that is arranged on a lower side of the lower polarizer and that transfers light from the light source to the lower polarizer, and a Flexible Printed Circuit Board (FPCB), which is placed at the edge of the glass substrate exposed by the lower polarizer, that supplies electric power to the light source, and that reflects light from the light source to the light waveguide.

12. The display panel of claim 11, wherein the display module further comprises a view area for displaying videos and a black matrix area, corresponding to the peripheral area of the view area, for blocking light from the light source.

13. The display panel of claim 12, wherein the FPCB is arranged at the edge of the glass substrate and is arranged such that the FPCB does not overlap the view area of the display module.

14. The display panel of claim 13, wherein the lower polarizer is arranged in an area on the lower side of the glass substrate corresponding to the view area.

15. The display unit of claim 11, wherein the FPCB comprises:
an electric power supply circuit connected to the light source; and
a coverlay for protecting and electrically isolating the electric power supply circuit and for reflecting light form the light source to the light waveguide.

16. The display panel of claim 15, wherein the coverlay is white.

17. The display panel of claim 13, wherein the display module further comprises an upper polarizer that is arranged on an upper side of the glass substrate.
